(19) United States
(12) Patent Application Publication
(10) Pub. No.: US 2010/0105010 A1
(43) Pub. Date: Apr. 29, 2010

(54) Methods and systems for producing demonstration and therapeutic models of dentition

(76) Inventor: James Mah, Las Vegas, NV (US)

Correspondence Address: James Mah, P.O. Box 15288, Las Vegas, NV, 89114, US

(21) Appl. No.: 12/290,280

(22) Filed: Oct. 29, 2008

(51) Int. Cl. A61C 5/08

(52) U.S. Cl. 433/215; 433/24

(57) ABSTRACT

In certain embodiments, the present invention relates to methods for producing demonstration models of dentition, which may be used for a variety of purposes, including, for example, installing dental implants in a patient and designing orthodontic devices. According to certain embodiments of the invention, methods for installing dental implants in a patient are provided. The methods generally comprise producing a demonstration model of a patient's teeth and a pilot hole for a dental implant and using the model as,a guide for drilling a pilot hole at the implant site. According to such embodiments, the step of producing the demonstration model comprises (a) capturing a digital image of patient's mouth region using a digital image acquisition system, (b) performing a digital image segmentation of the patient's teeth apart from a set of volumetric data (to produce a segmented image of the teeth), (c) identifying the implant site for the dental implant within the segmented image, (d) deriving the pilot hole and dimensions thereof at the implant site within the segmented image, and (e) manufacturing a real-sized demonstration model of the patient's teeth with the pilot hole disposed therein. The invention provides that a drill sleeve may be secured to the real-sized demonstration model within the pilot hole to produce a transfer tray, which may then be placed in the patient's mouth. According to such embodiments, the drill sleeve may be used as a guide for the pilot drill, such that the implant may thereafter be installed in the patient's mouth.

### FIELD OF THE INVENTION

The field of the present invention relates to dentistry and orthodontics. More particularly, the field of the present invention relates to methods for producing demonstration models of dentition, which may be used for a variety of purposes, including, for example, installing dental implants in a patient, designing orthodontic devices, educational applications and illustrations, as well as for aiding communication between dental practitioners and patients.

### BACKGROUND OF THE INVENTION

Dental implants are installed to provide a patient with an artificial tooth root. Such implants are regularly used in prosthetic dentistry to, for example, support restorations that are aesthetically and functionally similar to a real tooth or group of teeth. There are several types of dental implants used by dentists and orthodontists, the majority of which may be characterized as osseointegrated implants and fibrointegrated implants. The most widely used implant today is the osseointegrated implant, which is typically secured to a patient's mouth by fusing titanium screws into a patient's jawbone. It has been shown that osteoblasts grow at the titanium-to-bone interface, which serves to form a structural and functional connection between the living bone and the implant. Variations of such implant procedures are the implant-supported bridge and implant-supported denture.

The application of orthodontic devices to a patient's teeth is yet another procedure that is readily practiced by dentists and orthodontists. Non-limiting examples of such devices include orthodontic retainers, braces, and headgear. Of course, such devices are typically used to rearrange a patient's teeth.

The practice of installing dental implants and designing orthodontic devices would benefit from having a model of a patient's mouth and dentition, such that precise measurements and tools may be derived prior to installation of the implant—or designing and applying the orthodontic device to the patient's teeth. For years, dentists and orthodontists have produced physical, plaster molds for this purpose, which is labor intensive and suffers from a variety of other drawbacks. The present invention is designed to employ modern image acquisition and analysis systems and rapid prototyping techniques, such as stereolithography, to produce virtual and physical models of a patient's teeth and dental arch, such that many of the drawbacks associated with conventional plaster molds (and other prior art techniques) are obviated.

### SUMMARY OF THE INVENTION

According to certain aspects of the present invention, methods for installing dental implants in a patient are provided. The methods generally comprise producing a demonstration model of a patient's teeth and a pilot hole located therein for a dental implant—and using the model as a guide for drilling the pilot hole at the implant site. According to such embodiments, the step of producing the demonstration model comprises (a) capturing a digital image of the patient's mouth region using a digital image acquisition system, (b) performing a digital image segmentation of the patient's teeth apart from a set of volumetric data (to produce a segmented image of the teeth), (c) identifying the implant site for the dental implant within the segmented image, (d) deriving a virtual pilot hole and the dimensions thereof at the implant site within the segmented image, and (e) manufacturing a real-sized demonstration model of the patient's teeth with the pilot hole disposed therein. The invention provides that a drill sleeve may be secured to the real-sized demonstration model within the pilot hole to produce a transfer tray, which may then be placed in the patient's mouth. According to such embodiments, the drill sleeve may be used as a guide for the pilot drill, such that the implant may thereafter be installed in the patient's mouth.

According to additional embodiments of the present invention, methods for producing a demonstration model of a patient's mouth for analyzing tooth movement and configuring orthodontic devices are provided. Such methods generally comprise producing a demonstration model of a patient's teeth. The demonstration model is, preferably, produced by (a) capturing a digital image of at least a mouth portion of the patient's head using a digital image acquisition system, (b) performing a digital image segmentation of the patient's teeth apart from a set of volumetric data to produce a model exhibiting a dental arch that exists apart from the patient's teeth (preferably, the dental arch will show a set of dental sockets located therein), (c) manufacturing a real-sized demonstration model of the patient's teeth and a real-sized demonstration model of the patient's the dental arch, and (d) manufacturing one or more iterations of the real-sized demonstration model of the patient's dental arch, such that each of the iterations shows a series of new tooth locations and corresponding sockets. According to such embodiments, the real-sized demonstration model of the patient's teeth may then be inserted into one or more iterations of the real-sized demonstration models of the patient's dental arch—to demonstrate tooth movements. Still further, according to certain embodiments, an orthodontic device for tooth movement may then be designed and applied to the patient's teeth. The orthodontic device may be designed and configured based on, for example, the real-sized demonstration model of the patient's teeth when inserted into the desired iteration of the real-sized demonstration model of the patient's dental arch.

According to still further embodiments, the present invention encompasses systems that may be used for carrying out the foregoing methods. The systems may include, for example, a stereolithography apparatus, a digital image acquisition system, a personal computer, and image analysis software.

The above-mentioned and additional features of the present invention are further illustrated in the Detailed Description contained herein.

### BRIEF DESCRIPTION OF THE FIGURES

FIG. 1 is a flow diagram of the methods described herein for producing demonstration models of dentition, which may be used for installing dental implants in a patient.

FIG. 2 is a continuation of the flow diagram of FIG. 1.

FIG. 3 is a drawing of a virtual model of a patient's teeth, with a virtual pilot drill channel disposed therein.

FIG. 4 is a drawing of a real-sized demonstration model of a patient's teeth, with a pilot drill channel disposed therein.

FIG. 5 is a flow diagram of the methods described herein for producing demonstration models of dentition, which may be used for designing and installing orthodontic devices.

FIG. 6 is a continuation of the flow diagram of FIG. 5.

### DETAILED DESCRIPTION OF THE INVENTION

The following will describe, in detail, several preferred embodiments of the present invention. These embodiments are provided by way of explanation only, and thus, should not unduly restrict the scope of the invention. In fact, those of ordinary skill in the art will appreciate upon reading the present specification and viewing the present drawings that the invention teaches many variations and modifications, and that numerous variations of the invention may be, employed, used and made without departing from the scope and spirit of the invention.

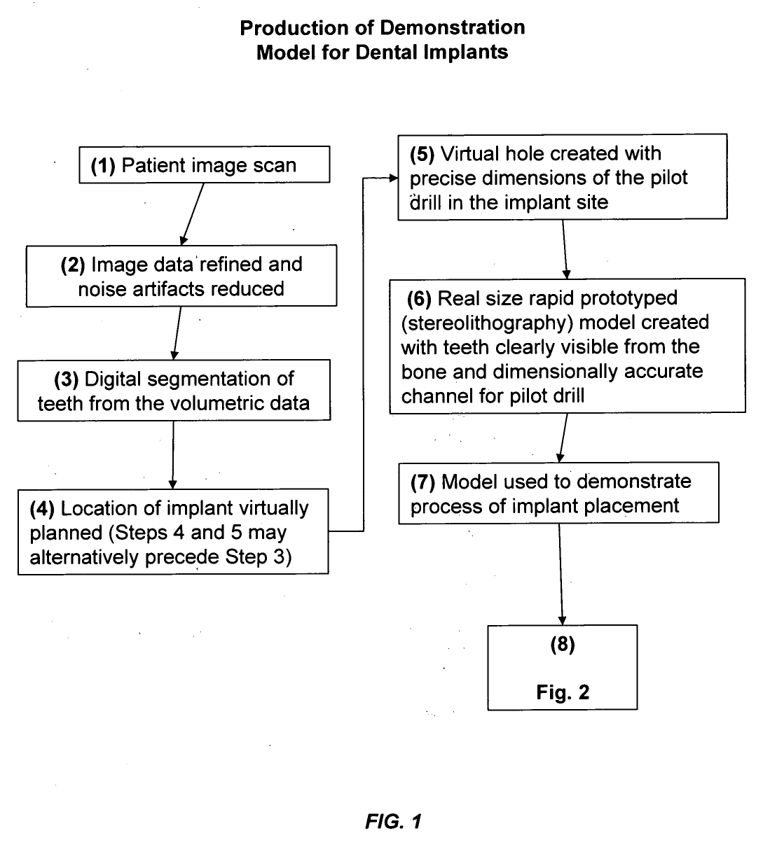

According to certain embodiments of the present invention, methods for installing dental implants in a patient are provided. The methods generally begin by producing a demonstration model of a patient's teeth. The demonstration model will preferably include a pilot hole, which may be used by a dentist or orthodontist as a guide for drilling a pilot hole at the implant site. Referring to FIG. 1, the methods generally comprise capturing a digital image of patient's mouth region (1) using a digital image acquisition system. A digital image acquisition system is preferably a device, such as an intra-oral camera, x-ray scanner, ultrasound equipment, magnetic resonance imaging (MRI) equipment, and other devices, which are capable of capturing a digital image of a patient's mouth region and, more preferably, is capable of capturing a three-dimensional image thereof, which does not require the use of,photographic film. For example, x-ray based equipment that may be utilized include medical computed topography (CT) (e.g., the LightSpeed® RT device offered by GE Healthcare) and cone-beam CT (e.g., the i-CAT® machine offered by Imaging Sciences International (Hatfield, Pa.)). Non-limiting examples of intra-oral cameras include the Brontes camera offered by 3M Co. (St. Paul, Minn.), the iTero camera offered by Cadent, Inc. (Carlstadt, N.J.), the OraScanner offered by OraMetrix, Inc. (Richardson, Tex.), and others. Still further, certain indirect methods of creating such digital models may be employed. For example, the invention provides that a scan of a dental impression may be generated, and then indirectly converted into a digital model, such as by taking a cone-beam CT scan of the dental impression to create the digital model.

Next, the invention provides that the image data is preferably refined (2), such that unwanted artifacts and noise are removed from the digital image. The methods further comprise performing a digital image segmentation of the patient's teeth apart from a set of volumetric data (3). This step will produce a segmented image of the patient's teeth, which is extracted away from all other parts of the image (the volumetric data). The invention provides that digital image segmentation involves a process whereby the digital image of the patient's mouth region is divided into a plurality of discrete regions—based on criteria specified by the individual who is conducting the segmentation—such that portions thereof may then be reassembled into an extracted object from the volumetric data. Such criteria may include, for example, predefined shapes, volumes, a three-dimensional area within a set of volumetric data, color-related criteria, and others.

In the present invention, the segmentation may be carried out using commercially-available image analysis software, such as Mimics Medical Imaging Software, SimPlant Master, and SimPlant OMS (all offered by Materialise US (Ann Arbor, Mich.)), NIH-Image Software (offered by the National Institute of Health (Bethesada, Md.)), 3D Slicer Software (offered by Brigham & Women's Hospital, an affiliate of Harvard Medical School), Analyze Software (offered by AnalyzeDirect, Inc. (Overland Park, Kans.)), as well as image analysis software offered by Amira (Carlsbad, Calif.). Digital image segmentation allows for object-based image analysis, such as specific analysis of a patient's teeth, teeth sockets, dental arch, or combinations thereof. Such object-based image analysis may isolate the desired object, e.g., teeth, dental arch, etc, by differentiating background and foreground from the object in the segmented image. In addition to isolating the object that will be the subject of the image analysis, e.g., teeth, dental arch, etc, by reducing the area which is subjected to an image processing analysis, processing time is reduced substantially for many real-time algorithms. This is particularly advantageous for algorithms that are implemented within a digital image acquisition device—where a dentist or orthodontist may wish to apply image processing and analysis at the point-of-care.

Still further, the invention provides that parts of the segmented objects may be fabricated. For example, parts of the segmented data may be supplemented with, or replaced by, artificial objects. In the event that parts of the segmented data are missing or otherwise exhibit less than satisfactory resolution, the missing or defective data may be replaced with fabricated data. The fabricated data may correspond to, for example, a tooth or set of teeth that are not critical to the practitioner's analysis. As such, the missing or defective data may be replaced with fabricated data, which are representative of a typical tooth in the applicable location. In addition, the fabricated data may be designed to resemble the anatomy of the applicable tooth or, in certain alternative embodiments, may exhibit a generic element, such as a cylinder, triangle, other suitable shapes, or combinations thereof, to simply indicate the presence of a tooth—but not necessarily the representative anatomy thereof. The use of such fabricated data is particularly advantageous when the fabricated data are used in areas that are not critical or subject to the practitioner's analysis, in which case the very presence of fabricated data should be indicative to a viewer that such portions of the data are not relevant to the analysis (and, preferably, would cause a viewer to focus his/her attention on the actual, anatomically-correct segmented data). Still further, the use of fabricated data, and particularly generic shapes instead of anatomically-correct shapes, would be advantageous insofar as it would reduce the cost and labor associated with manufacturing the corresponding models, e.g., the cost and labor involved in prototyping a basic cylinder will be less than an anatomically-correct and patient-specific tooth.

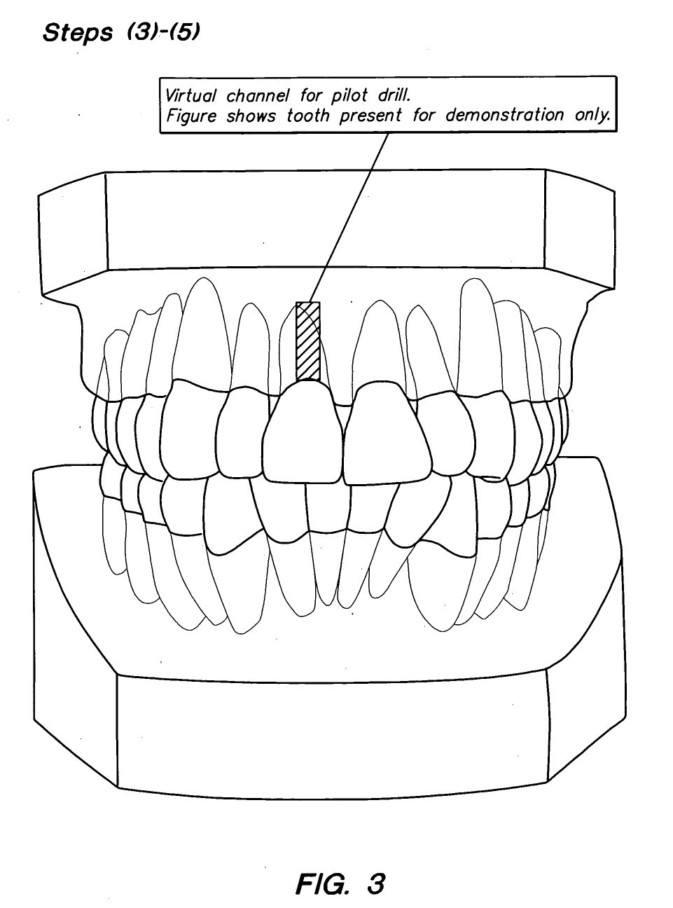

The methods further comprise identifying the implant site (for the dental implant) within the segmented image (4). At this point, a virtual pilot hole (and the dimensions thereof) may be derived at the implant site within the segmented image (5). The dimensions of the pilot hold may include, for example, its location in the proximity of the patient's dentition, as well as the diameter and depth of the virtual pilot hole. FIG. 3 provides an exemplary segmented image of a patient's mouth region, which shows the virtual pilot hole superimposed therein.

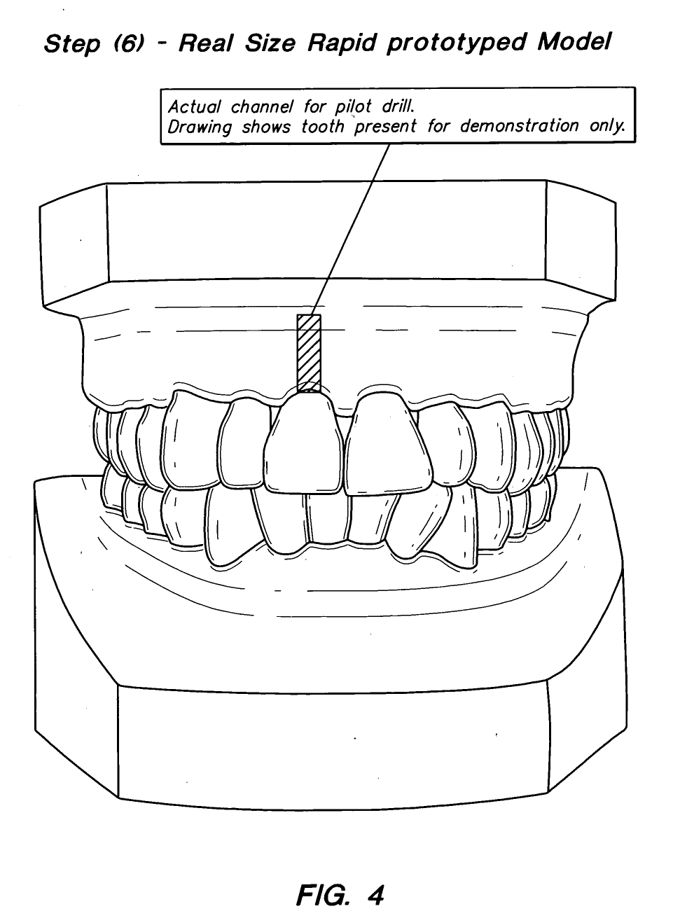

The methods of the present invention further comprise manufacturing a real-sized demonstration model of the patient's teeth with the pilot hole disposed therein (6). An exemplary drawing of a real-sized demonstration model of a patient's teeth, with the pilot hole disposed therein, is provided in FIG. 4. The invention provides that the real-sized demonstration model may be manufactured using stereolithography.

Stereolithography is a manufacturing process that may be employed for rapidly and accurately producing the teeth and dental arch models described herein. A commercially-available stereolithography apparatus (SLA) may be employed to carry out the rapid prototyping methods described herein. In many cases, stereolithography is carried out using a defined amount of liquid UV-curable photopolymer, which is also referred to as “resin,” and an ultraviolet (UV) laser to assemble the model one layer at a time. According to such methods, the laser beam will “trace” a cross-sectional pattern, for each layer of the model, on the surface of the liquid resin. By exposing the resin to UV energy, the resin solidifies (or “cures”) in accordance with the pattern traced by the beam of energy, which adheres to the layer beneath it.

After a pattern has been traced by the beam of UV energy, a so-called elevator platform within the SLA descends by a single layer thickness, typically about 0.05 mm to 0.15. Next, a resin-filled blade traverses across each part of the cross-section, which re-coats the model with new UV-curable resin. On this new layer of resin, the subsequent layer pattern is traced, adhering to the previous layer. This process allows for a complete three-dimensional, real-sized prototyped model to be produced. After the prototyped model is produced, the model may, optionally, be cleaned and the excess resin removed therefrom by immersion in a chemical bath and then cured in a UV oven. U.S. Pat. No. 4,575,330 (“Apparatus for Production of Three-Dimensional Objects by Stereolithography”) provides a non-limiting method of stereolithography, which may be used in the present invention and is hereby incorporated by reference in its entirety.

In addition to stereolithography, the invention provides that other manufacturing methods may be employed to prepare the real-sized demonstration model. For example, CNC (computer numerical control) milling procedures, powder deposition, wax-based printing, or combinations thereof may be utilized to prepare such model. In certain embodiments, stereolithography is used in combination with other procedures to prepare the real-sized demonstration model. For example, stereolithography may be utilized to prepare the teeth portion of such model, whereas the base and teeth sockets may be formed using a CNC milling procedure. This type of combinatorial manufacturing approach will serve to facilitate manufacturing and reduce the cost thereof.

As described herein, the real-sized demonstration model may consist of multiple segmented parts, such as the base, dental arch, separated teeth, and others. As such, the invention provides that the model may further comprise elements that allow such parts to be reversibly connected to each other, such as mechanical fasteners and/or other retentive features. Non-limiting examples of such fasteners and retentive features include screws, ball-and-sockets, tongue-and-grooves, clasps, buttons, friction-fit components, dovetail/parallel channels, retentive ridges and grooves, Velcro® adhesion, and others. Still further, the invention provides that magnets may be employed to reversibly hold the various segmented parts of the model together (e.g., a first corresponding part may be provided with a thin metal plate or a metallic coating, whereas a second corresponding part may be provided with a magnet). This way, a practitioner may easily assemble and disassemble the model for any of various reasons, such as for illustration purposes, educational purposes, examination of the model, etc.

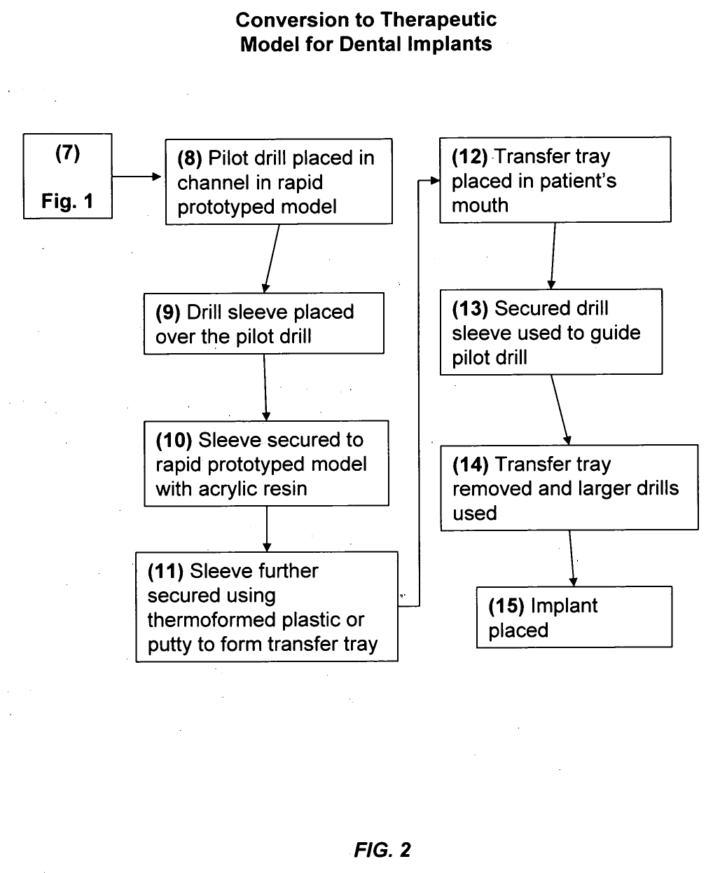

As described herein, the real-sized demonstration model may be used to demonstrate the process of dental implant placement (7) to a patient and, moreover, may serve as a guide during implant insertion. Referring to FIG. 2, if the real-sized demonstration model is used as a guide during implant insertion, the invention provides that a pilot drill may be placed in the pilot hole (or channel) located within the demonstration model (8), and a drill sleeve may be placed over the pilot drill (9) and secured to the model (10). This will produce a “transfer tray,” which (as explained further below) may then be placed in the patient's mouth and used during installation of the dental implant. According to such embodiments, the drill sleeve may be used as a guide for the pilot drill, such that the implant may thereafter be installed in the patient's mouth. The invention provides that, in certain embodiments, the drill sleeve may be secured to the real-sized demonstration model with acrylic resin (10). Still further, the invention provides that the drill sleeve may be further secured to the real-sized demonstration model using thermoformed plastic (11).

Acrylic resins are a group of related thermoplastic or thermosetting plastic substances that are derived from acrylic acid, methacrylic acid, derivatives thereof, and/or other related compounds. In general, acrylic resins are formed by causing a plurality of monomers to polymerize (i.e., to form a polymer) by applying a polymerization initiator and heat to such monomers. The chemical name of a commonly-used monomer is methyl methacrylate monomer (MMA), which polymerizes to form polymethyl methacrylate (PMMA). MMA is a relatively transparent and colorless fluid, which causes the polymerized PMMA form to also exhibit a relatively high transparency. Thus, the resulting relatively transparent characteristics of the demonstration model facilitates examination of the patient's teeth, dental arch, and/or the pilot hole from a plurality of different angles and perspectives.

As described above, once the drill sleeve is secured to the demonstration model (10) and (11), a “transfer tray” is formed which may be placed in a patient's mouth (12). Next, a first drill may be used to bore a pilot hole into the patient's jawbone using the drill sleeve as a guide (13). The first drill and transfer tray may then be removed from the patient's mouth, such that a second larger drill may be used to create a larger and appropriately-dimensioned hole (14), such that the dental implant may be installed (15). The invention provides that two or more separate and progressively-larger drill sizes may be employed until a hole is formed having the requisite dimensions for the dental implant, which hole is often referred to as the “osteotomy.”

The dental implant that is installed using the foregoing processes may be, for example, one or more osseointegrated implants and/or fibrointegrated implants. A typical implant includes a titanium screw (which resembles a tooth root). The titanium screw may exhibit a roughened or smooth surface, but will preferably be configured to facilitate osseointegration. The implant screw may be comprised of substantially pure titanium or, more preferably, will be comprised of TiAl₆V₄ alloy, which has been shown to exhibit an advantageous combination of osseointegration characteristics and tensile strength (which will mitigate the risk of fractures). The invention further provides that the dental implant screws, which are preferably comprised of TiAl₆V₄ alloy, may be treated via plasma spraying, etching or sandblasting to increase the surface area thereof, which serves to enhance the integration of the screw in the patient's jawbone.

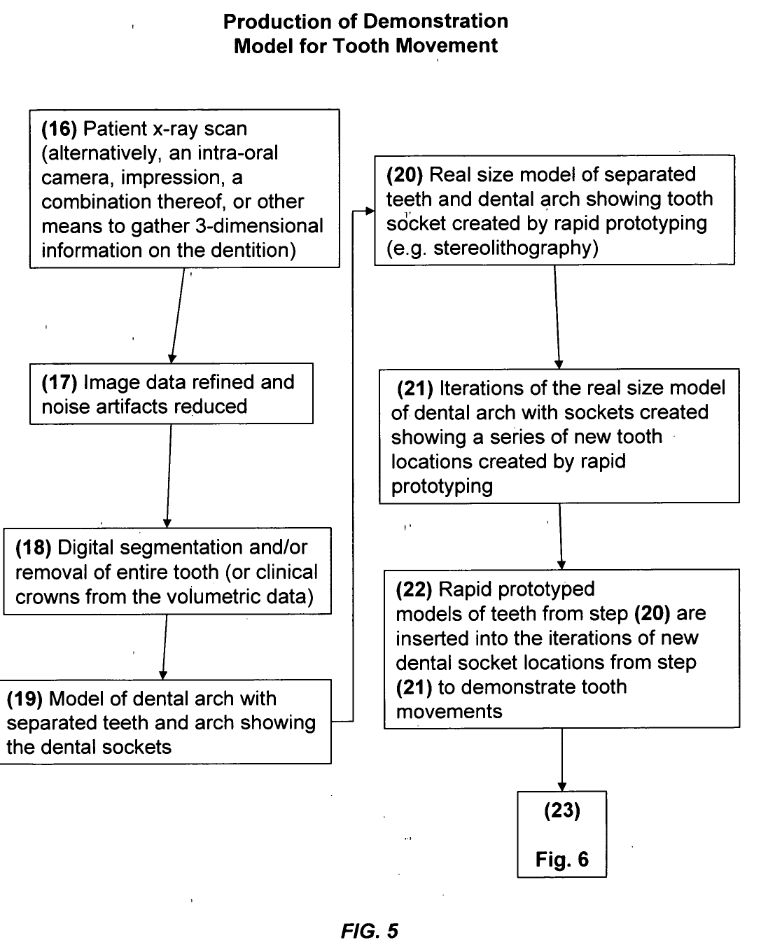

According to additional embodiments of the present invention, methods for producing a demonstration model of a patient's mouth for analyzing tooth movement and configuring orthodontic devices are provided. Such methods generally begin with producing a demonstration model of a patient's teeth. Referring to FIG. 5, the demonstration model is, preferably, produced by first capturing a digital image of at least a mouth portion of the patient's head using a digital image acquisition system (16), such as an x-ray scanner, intra-oral cameras, and/or other devices or procedures. According to such embodiments, the invention provides that the image data may then be refined (17), such that unwanted artifacts and noise are removed from the digital image. The methods further comprise performing a digital image segmentation (18) to produce a model of the patient's dental arch, with the teeth separated therefrom, such that the dental sockets within the arch may be examined (19).

Still referring to FIG. 5, the digitally segmented image may then be used to produce a real-sized demonstration model of a patient's teeth, and a real-sized demonstration model of a separated dental arch showing teeth sockets disposed therein (20). The real-sized demonstration model may be manufactured using stereolithography, as described herein. According to certain embodiments of the invention, the methods further comprise manufacturing one or more iterations of the real-sized demonstration model of the patient's dental arch, such that each of the iterations shows a series of new tooth locations and corresponding sockets (21). According to such embodiments, the real-sized demonstration model of the patient's teeth (from step (20)) may then be inserted into one or more of the iterations of the real-sized demonstration models of the patient's dental arch (22)—to demonstrate tooth movements.

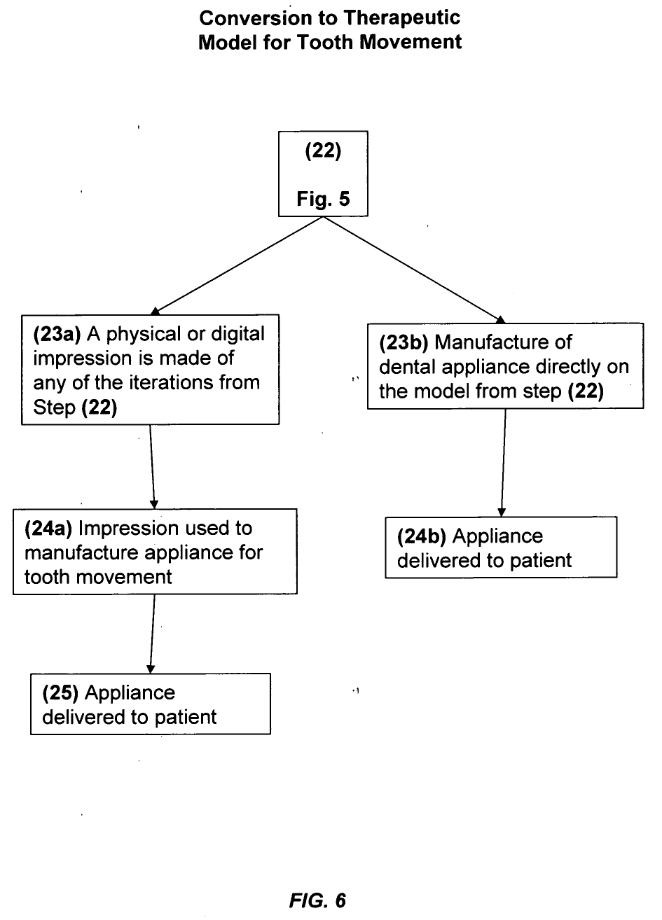

Referring now to FIG. 6, the invention provides that an orthodontic device for tooth movement may be designed and configured based on, for example, the real-sized demonstration model of the patient's teeth when inserted into the desired iteration of the real-sized demonstration model of the patient's dental arch (23b). At that point, the orthodontic device may then be applied to the patient's teeth (24b). Alternatively, a physical or digital impression may be created (23a) based on the real-sized demonstration model of the patient's teeth—when inserted in any of the iterations of the real-sized demonstration model of the patient's dental arch. Next, the orthodontic device may be manufactured (24a) based on the physical or digital impression, such that the device may then be applied to the patient's teeth (25).

According to still further embodiments, the present invention encompasses systems that may be used for carrying out the foregoing methods. The systems may include, for example, a stereolithography apparatus, a digital image acquisition system, a personal computer, and image analysis software.

The many aspects and benefits of the invention are apparent from the detailed description, and thus, it is intended for the following claims to cover all such aspects and benefits of the invention which fall within the scope and spirit of the invention. In addition, because numerous modifications and variations will be obvious and readily occur to those skilled in the art, the claims should not be construed to limit the invention to the exact construction and operation illustrated and described herein. Accordingly, all suitable modifications and equivalents should be understood to fall within the scope of the invention as claimed herein.

What is claimed is:

1. A method for installing dental implants in a patient, which comprises:
(a) producing a demonstration model of a patient's teeth and a pilot hole for a dental implant, wherein the step of producing the demonstration model comprises:
(i) capturing a digital image of at least a mouth portion of the patient's head using a digital image acquisition system;
(ii) performing a digital image segmentation of the patient's teeth apart from a set of volumetric data to produce a segmented image of the teeth;
(iii) identifying an implant site for the dental implant within the segmented image;
(iv) deriving the pilot hole and dimensions thereof at the implant site within the segmented image; and
(v) manufacturing a real-sized demonstration model of the patient's teeth with the pilot hole disposed therein; and
(b) securing a drill sleeve to the real-sized demonstration model within the pilot hole to produce a transfer tray;
(c) placing the transfer tray in the patient's mouth;
(d) drilling a pilot hole using the drill sleeve as a guide for a pilot drill; and
(e) installing the dental implant.

2. The method of claim 1, which further comprises eliminating unwanted artifacts from the digital image.

3. The method of claim 2, wherein the real-sized demonstration model is manufactured using stereolithography.

4. The method of claim 3, wherein the step of securing a drill sleeve to the real-sized demonstration model within the pilot hole comprises (a) placing a pilot drill in the pilot hole and (b) placing the drill sleeve over the pilot drill.

5. The method of claim 4, wherein the drill sleeve is secured to the real-sized demonstration model with acrylic resin.

6. The method of claim 5, wherein the drill sleeve is further secured to the real-sized demonstration model with thermoformed plastic.

7. The method of claim 6, wherein the steps of installing the dental implant using the drill sleeve as a guide for a pilot drill comprise:
(a) boring a pilot hole with a first drill using the drill sleeve as a guide;
(b) removing the transfer tray from the patient's mouth;
(c) boring a larger hole with a second drill; and
(d) installing the dental implant in the larger hole.

8. The method of claim 7, wherein the dental implant is selected from the group consisting of osseointegrated implants and fibrointegrated implants.

9. A method for producing a demonstration model of a patient's mouth for analyzing tooth movement and configuring orthodontic devices, which comprises:
(a) producing a demonstration model of a patient's teeth, wherein the step of producing the demonstration model comprises:
(i) capturing a digital image of at least a mouth portion of the patient's head using a digital image acquisition system;
(ii) performing a digital image segmentation of the patient's teeth apart from a set of volumetric data to produce a model exhibiting a dental arch apart from a set of teeth, wherein the dental arch shows a set of dental sockets located therein;
(iii) manufacturing a real-sized demonstration model of the patient's teeth and a real-sized demonstration model of the patient's the dental arch; and
(iv) manufacturing one or more iterations of the real-sized demonstration model of the patient's dental arch, wherein each of the iterations shows a series of new tooth locations and corresponding sockets; and
(v) inserting the real-sized demonstration model of the patient's teeth into one or more iterations of the real-sized demonstration model of the patient's dental arch to demonstrate tooth movements;
(b) manufacturing an orthodontic device for tooth movement; and
(c) applying the orthodontic device to the patient's teeth.

10. The method of claim 9, wherein the orthodontic device is manufactured and applied to the patient's teeth by the steps of:
(a) manufacturing a physical or digital impression of the real-sized demonstration model of the patient's teeth inserted in any of the iterations of the real-sized demonstration model of the patient's dental arch; manufacturing the orthodontic device based on the physical or digital impression; and applying the orthodontic device to the patient's teeth; or
(b) manufacturing the orthodontic device based on the real-sized demonstration model of the patient's teeth inserted in any of the iterations of the real-sized demonstration model of the patient's dental arch and applying the orthodontic device to the patient's teeth.

11. The method of claim 10, wherein the digital image acquisition system is an x-ray scanner, intra-oral camera, oral cavity impression, or a combination thereof.

12. The method of claim 11, which further comprises eliminating unwanted artifacts from the digital image.

13. The method of claim 12, wherein the real-sized demonstration model is manufactured using stereolithography.

14. The method of claim 13, wherein the orthodontic devices are orthodontic retainers, braces, headgear, or combinations thereof.
